(19) United States
(12) Patent Application Publication
(10) Pub. No.: US 2016/0149241 A1
(43) Pub. Date: May 26, 2016

(54) APPARATUS AND METHOD FOR DISCHARGING RESIDUAL ELECTRIC ENERGY OF FUEL CELL

(71) Applicants: Hyundai Motor Company, Seoul (KR); Kia Motors Corporation, Seoul (KR)

(72) Inventors: Ju Han Kim, Yongin (KR); Jung Do Suh, Seoul (KR); Yong Sun Park, Yongin (KR); Young Bum Kum, Seoul (KR); Sei Hyun Lee, Daejeon (KR)

(21) Appl. No.: 14/929,259

(22) Filed: Oct. 31, 2015

(30) Foreign Application Priority Data
Nov. 24, 2014 (KR) 10-2014-0164208

(51) Int. Cl. H01M 8/04

(52) U.S. Cl. CPC H01M 8/04664; H01M 8/04992; H01M 8/04955; H01M 2250/20

(57) ABSTRACT

An apparatus and a method for discharging a residual electric energy of a fuel cell can rapidly discharge and remove a residual electric energy of a fuel cell for safety after the fuel cell is operated or when a collision is detected. The apparatus for discharging the residual electric energy of the fuel cell includes: a discharge relay connected with a fuel cell and turned on when starting or stopping a vehicle or a collision detecting sensor detects a collision; and a non-linear protecting element connected with the discharge relay in order to discharge a residual electric energy from the fuel cell.

### CROSS-REFERENCE TO RELATED APPLICATION

This application claims under 35 U.S.C. §119(a) the benefit of Korean Patent Application No. 10-2014-0164208 filed on Nov. 24, 2014, the entire contents of which are incorporated herein by reference.

### BACKGROUND

(a) Technical Field

The present invention relates to an apparatus and a method for discharging a residual electric energy of a fuel cell, and more particularly, to an apparatus and a method that rapidly discharge and remove a residual electric energy of a fuel cell for safety after the fuel cell is operated or when a collision is detected.

(b) Description of the Related Art

In a fuel cell stack mounted in a fuel cell vehicle, a residual reactant gas exists inside a channel of an isolation plate of the fuel cell stack even before and after starting, so that a residual voltage is present for a long time.

The residual voltage forms an overvoltage of a cell of a fuel cell immediately after operation of the fuel cell, so that carbon corrosion occurs in a cathode catalyst layer, thereby decreasing a lifespan of the fuel cell, and even after the operation of the fuel cell is stopped, a high voltage is left in the fuel cell stack by the residual voltage, so that there is a concern that electric shock may occur when a user is in direct contact with a charging unit.

Accordingly, in order to solve the problem, a discharging apparatus for consuming a residual electric energy of the fuel cell stack before and after starting is applied to a fuel cell vehicle.

FIG. 1 (RELATED ART) illustrates a basic discharge process of a fuel cell stack.

Referring to FIG. 1, a general discharge process of the fuel cell stack is a process in which, when starting or stopping a vehicle during normal operation, i.e., when an ignition switch is turned on or off, or after a collision is detected by a collision detecting sensor, electric energy left in the fuel cell stack is consumed through a discharge resistor by operating a relay of a discharging apparatus.

FIG. 2 (RELATED ART) is a circuit diagram illustrating a discharging apparatus of a fuel cell stack of the related art.

Referring to FIG. 2, the discharging apparatus of the related art has a method using an electric resistance element, and includes a discharge relay 10 turned on when starting or stopping of a vehicle (i.e., an ignition switch is turned on or off), or when a collision is detected by a collision detecting sensor when the collision occurs, and an electric resistance element 12 for discharging a residual electric energy (current) from a cell of a fuel cell, the electric resistance element 12 being disposed in a coolant duct line 14 of a Thermal Management System (TMS) of a fuel cell system for cooling.

Accordingly, in a state where a fuel cell relay 18 between a high voltage load 16 and a fuel cell 20 is turned off, and a high voltage battery relay 24 between a high voltage battery 22 and the high voltage load 16 is turned off, the residual electric energy of the fuel cell is discharged through the electric resistance element 12 via the on-state discharge relay 10.

However, a temperature of the electric resistance element is sharply increased by Joule heat generated by a discharging current, so that a separate cooling device, such as the coolant duct line, is necessary, and thus a configuration of the discharging apparatus is complex and volume thereof is increased.

Further, there is a disadvantage in that a discharging time by the electric resistance element is consumed by several seconds or more, so that a residual voltage exists in the fuel cell stack for a predetermined time even right after an accident (e.g., a collision).

Accordingly, a high-voltage charging unit inevitably maintains an activated state before a residual voltage is discharged from the fuel cell stack to a safe level for a person, so that when the high-voltage charging unit is in contact with the person, there is concern about the possibility of electric shock.

Further, when the fuel cell is severely damaged by collision, arc is generated by an electric short-circuit by the residual electric energy of the stack, so that secondary damage, such as electrical fire, may result.

### SUMMARY

Accordingly, it is an object of the present invention to provide an apparatus and a method of discharging a residual electric energy of a fuel cell stack, for rapidly removing a residual electric energy of a fuel cell stack by using a non-linear protecting element used for protecting a load device and the like from an excessive overvoltage.

In accordance with an aspect of the present invention, there is provided an apparatus for discharging a residual electric energy of a fuel cell, including: a discharge relay connected with a fuel cell and turned on when a vehicle is started or stopped (ignition switch is turned on/off), or a collision detecting sensor detects a collision, or in a predetermined situation during operation of a vehicle including a collision, flooding, and insulating aging or a dielectric breakdown of a high-voltage component, and when insulating resistance of the vehicle is decreased to a reference level or lower; and a non-linear protecting element connected with the discharge relay in order to discharge a residual electric energy from the fuel cell.

The non-linear protecting element may be one or a combination of two or more selected from a Gas Discharging Tube (GDT), a Metal Oxide Varistor (MOV), and a Transient Voltage Suppressor (TVS) diode.

The apparatus may further include a high-voltage trigger configured to generate high-voltage trigger power in a pulse form and apply the generated high-voltage trigger power to the non-linear protecting element.

In accordance with another aspect of the present invention, there is provided a method of discharging a residual electric energy of a fuel cell, including: determining whether a residual electric energy discharging condition of a fuel cell is satisfied; when the residual electric energy discharging condition of the fuel cell is satisfied, turning on the fuel cell and a discharge relay, and configuring the fuel cell and a non-linear protecting element in a closed circuit; and discharging the residual electric energy of the fuel cell through the non-linear protecting element via the discharge relay.

The method may further include generating high-voltage trigger power in a pulse form and applying the generated high-voltage trigger power to the non-linear protecting element.

A discharging initiating voltage of the non-linear protecting element may be set to be lower than a voltage at a maximum load of a fuel cell stack.

Through the aforementioned technical solutions, the present invention provides the effects below.

First, it is possible to more rapidly remove a residual electric energy of a fuel cell stack after an operation of a fuel cell vehicle is stopped or when an accident (e.g., a collision) is detected, thereby considerably decreasing a danger of secondary damage, such as an electric shock accident of a driver and a rescuer or electrical fire due to a dielectric breakdown.

Second, it is possible to consume a large discharging current by using a small-volume non-linear protecting element, such as a GDT, thereby achieving a fast discharging effect and miniaturizing a discharging apparatus.

Third, the existing discharging apparatus requires a separate cooling means (a coolant duct line of a thermal management system, and the like) due to heat of an electric resistance element, but the discharging apparatus of the present invention does not require a separate cooling means because of use of the non-linear protecting element, thereby simplifying a configuration of the discharging apparatus.

Fourth, according to the miniaturization and the simplification of the discharging apparatus, it is possible to efficiently build a package and a layout of a fuel cell system.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 (RELATED ART) is a diagram illustrating a basic discharge process of a fuel cell stack;

FIG. 2 (RELATED ART) is a circuit diagram illustrating a discharging apparatus of a fuel cell stack of the related art;

FIG. 3 is a diagram illustrating a rapid discharge process of a fuel cell stack according to the present invention;

FIG. 4 is a circuit diagram illustrating a residual energy discharging apparatus of the fuel cell stack according to the present invention;

FIG. 5 is a diagram illustrating a type of non-linear element used in the discharging apparatus of the present invention;

FIG. 6 is a diagram illustrating a structure of a gas discharge tube used in the discharging apparatus of the present invention;

FIG. 7 is a graph illustrating a discharge characteristic of the gas discharge tube used in the discharging apparatus of the present invention;

FIG. 8 is a circuit diagram illustrating a discharge equivalent circuit of a fuel cell; and

FIG. 9 is a graph illustrating a transient characteristic of the discharge equivalent circuit of the fuel cell.

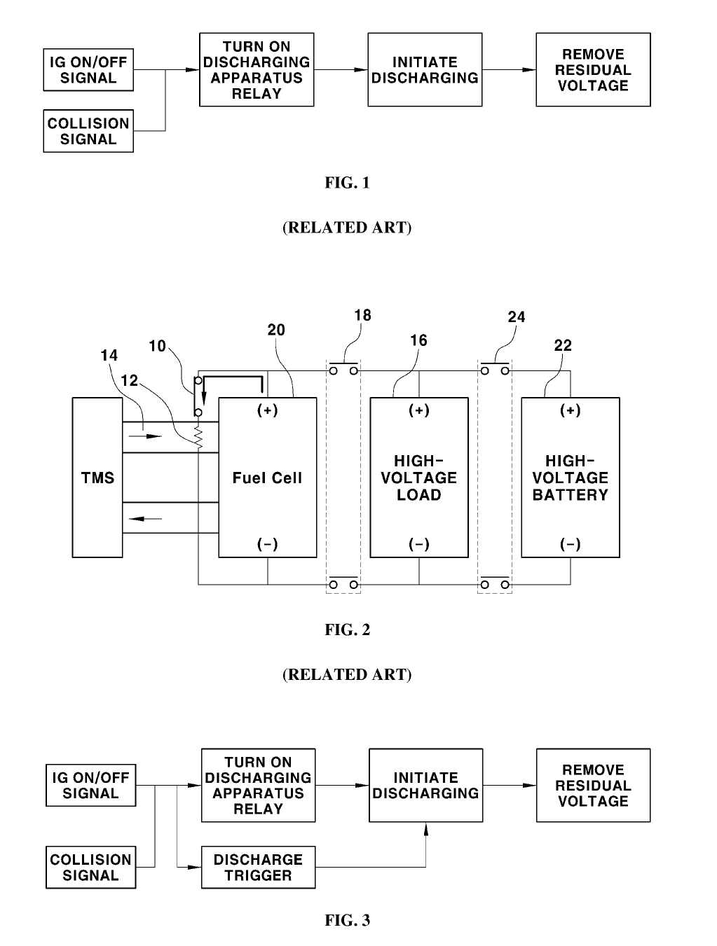

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present invention will be described in detail so that those skilled in the art to which the present invention pertains can easily carry out the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, an exemplary embodiment of the present invention will be described in detail with reference to the accompanying drawings.

First, in order to help understanding of the present invention, a basic circuit for discharging a residual electric energy of a fuel cell stack and an operation thereof will be described below.

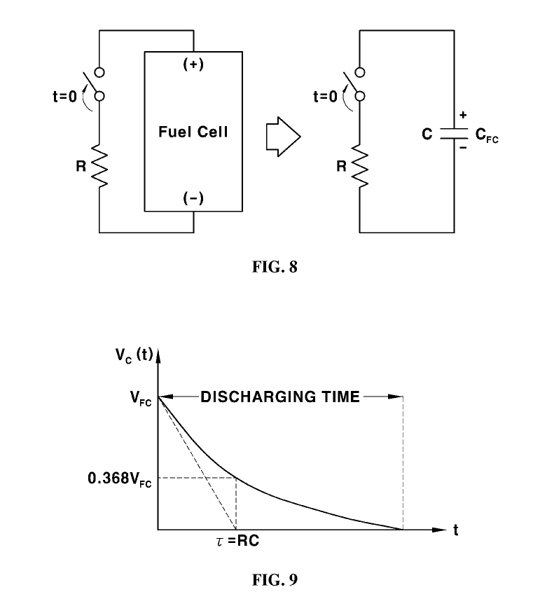

FIG. 8 is a circuit diagram illustrating a discharge equivalent circuit of a fuel cell.

As shown in FIG. 8, a discharge of a fuel cell may be equivalent to an RC serial circuit, and may be in a state in which a charged capacitor C is discharged through a resistor R, so that when a relay is switched in t=0, a capacitor voltage may be expressed by Equation 2 in conjunction with Equation 1 below.

$$\begin{matrix}\frac{d {v}_{c} ( t )}{d t} + \frac{{v}_{c} ( t )}{R C} = 0 & [ Equation 1 ] \\ {v}_{c} = {V}_{F C} \cdot {e}^{- t / R C} & [ Equation 2 ]\end{matrix}$$

In Equations 1 and 2, V_{FC} indicates an operating voltage of the fuel cell, v_{c}(t) indicates a transient voltage of an equivalent capacitor, R indicates an electric resistance of the discharging apparatus, t=0 indicates an operating time point of a discharging apparatus relay, and t indicates a time constant.

In this case, as shown in FIG. 9, the residual voltage V_{FC} of the fuel cell is exponentially decreased, and a decrease rate is dependent on a time constant (τ=RC), so that when resistance R of the discharge element is small, the fuel cell has a shorter discharging time.

Accordingly, the present invention focuses on a point that a residual voltage within a fuel cell stack may be rapidly discharged by using a non-linear protecting element having a characteristic that resistance of a discharge element is small.

In particular, the present invention provides an apparatus and a method for discharging a residual energy of a fuel cell stack, which are capable of rapidly discharging a residual voltage within a fuel cell stack by configuring a fuel cell discharging apparatus with a Gas Discharging Tube (GDT), a Metal Oxide Varistor (MOV), or a Transient Voltage Suppressor (TVS) diode, which correspond to a representative non-linear protecting element used for protecting a load device, and the like from a transient overvoltage flowing in a track in a power or communication circuit, or a combination thereof.

The non-linear protecting elements preferably are arrester elements, and when an overvoltage equal to or larger than an operation initiation voltage is applied, electric resistance is momentarily and rapidly decreased and thus the non-linear protecting elements becomes an electrical short-circuit state, so that it is possible to rapidly discharge electric energy, and when the discharging is completed, the non-linear protecting elements are recovered to an initial state to maintain an original insulating characteristic.

Further, the non-linear protecting elements have a discharging current capacity of several to several tens of kA, which is very large, despite small volume thereof, and have an operating speed for discharging of several ns to several ms, which is a very rapid response characteristic.

Accordingly, the present invention rapidly discharges the residual electric energy of the fuel cell stack, and has a large energy absorption quantity compared to the related art, so that it is not necessary to separately cool a liquid, and the present invention implements the discharging apparatus by using the non-linear protecting element having the aforementioned characteristic so as to considerably decrease volume of the discharging apparatus through the non-linear protecting element having small volume.

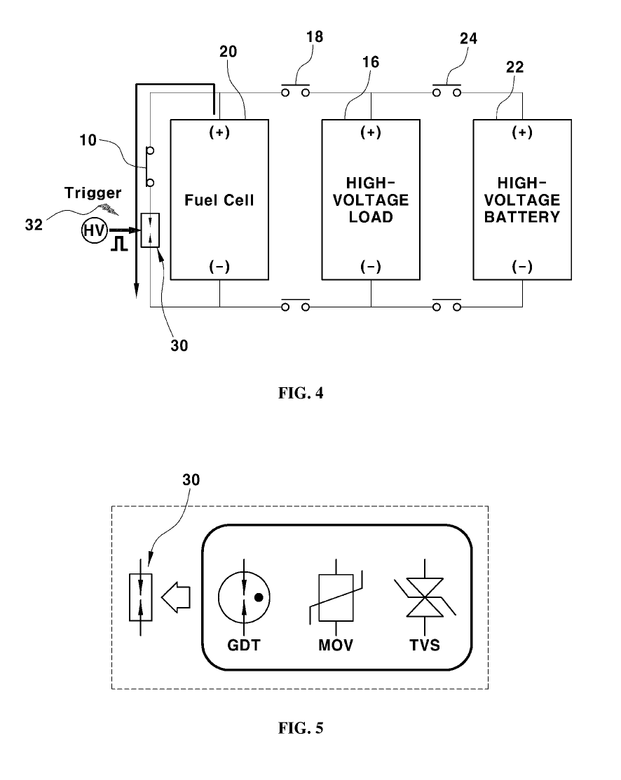

FIG. 3 is a diagram illustrating a rapid discharge process of a fuel cell stack according to the present invention, and FIG. 4 is a circuit diagram illustrating a residual energy discharging apparatus of the fuel cell stack according to the present invention.

As shown in FIG. 4, the discharging apparatus of the present invention includes a discharge relay 10 turned on when starting or stopping a vehicle (ignition switch is turned on/off), or a collision is detected by a collision detecting sensor when the collision occurs, and a non-linear protecting element connected with the discharge relay 10 in order to discharge residual electric energy (current) from a fuel cell.

Accordingly, in a state where a fuel cell relay 18 between a high voltage load 16 and a fuel cell 20 is turned off, and a high voltage battery relay 24 between a high voltage battery 22 and the high voltage load 16 is turned off, the residual electric energy of the fuel cell is discharged through the non-linear protecting element 30 via the on-state discharge relay 10.

In this case, referring to FIG. 5 illustrating a non-linear protecting element, the non-linear protecting element 30 may use one or a combination of two or more selected from a GDT, a MOV, and a TVS diode. In particular, the non-linear protecting element may be selected from the group consisting of: a GDT, a MOV, and a TVS diode. Alternatively, a plurality of non-linear protecting elements may be used, preferably including at least one of: a GDT, a MOV, and a TVS diode. A GDT may be used as the non-linear protecting element 30 because a discharging quantity of the GDT is excellent compared to other semiconductor protecting elements, and insulating performance of the GDT may be recovered compared to solid-state protecting mechanism, so that the GDT may be used several times without deformation or damage.

Further, the discharging apparatus of the present invention further includes a high-voltage trigger 32 for generating high-voltage trigger power in a pulse form from a direct-current power source and applying the generated power to an electrode located at a center inside the GDT in order to obtain a more rapid gas discharge characteristic.

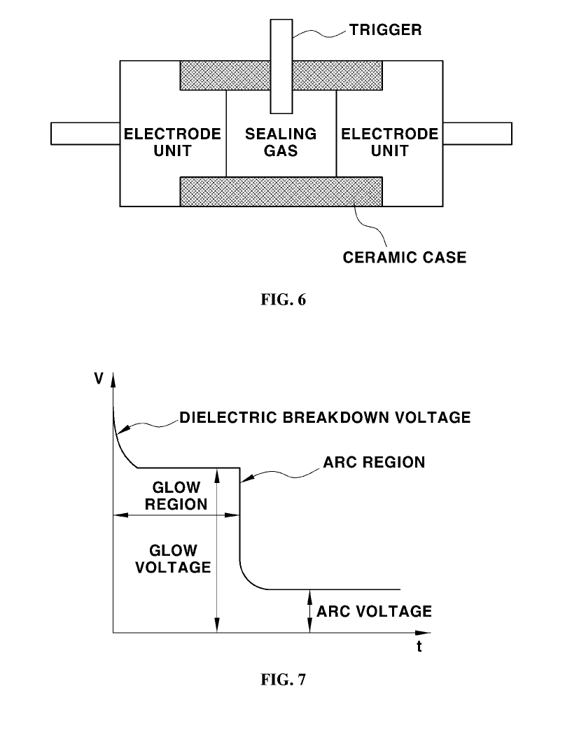

Accordingly, the GDT has a structure in which electrode units are disposed at both sides of a ceramic case, an internal side of the ceramic case is filled with sealing gas, and the high-voltage trigger 32 is mounted at one side of the ceramic case as illustrated in FIG. 6.

Here, in order to help understanding of the present invention, a characteristic of the GDT will be described below.

When a voltage equal to or smaller than the operation initiation voltage is applied to the GDT, insulating resistance is infinite, so that the GDT is maintained in a state having no leakage current, and this region is referred to as a non-operation region.

Further, when a voltage corresponding to the operation initiation voltage is both ends of the electrode of the GDT, energy enough for molecules of neutral gas between a positive electrode to be ionized is obtained, so that electrons are discharged, and a conductive path between the electrodes is formed by electron avalanche, a dielectric breakdown is incurred between the electrodes, and internal resistance of the discharge tube is sharply decreased, so that a very large current flows in the discharge tube.

In this case, a terminal voltage between the electrodes is maintained in several tens to several hundreds of V, and a voltage in this case is referred to as a glow voltage, and an operation region in this case is referred to as a glow region (see FIG. 7).

When the glow region is further progressed, the glow region becomes an arc region, in which a terminal voltage is several to several tens of V, and a discharging current is several to several tens of kA, which is a region performing a protecting operation, and when all of the discharging currents are discharged, the terminal voltage is increased to be close to the glow voltage and the operation of the discharge tube is stopped, and the ionized gas molecules are recombined to recover the initial insulating performance.

A discharge quantity of the GDT is more excellent than those of other semiconductor protecting element, and insulating performance of the GDT may be recovered compared to solid-state protecting mechanism, so that it is possible to use the GDT several times without deformation or damage, and further, the GDT has several pF, which is the smallest capacitance, among the non-linear protecting elements, so that a response characteristic of the GDT is very fast, and the GDT has a sealing structure, so that the GDT has a minimum change in an operation characteristic according to a use environment (temperature and humidity).

Accordingly, it is most preferable to use the GDT as the non-linear protecting element 30.

Here, a method of discharging a residual energy of the fuel cell of the present invention based on the aforementioned configuration will be described below.

As described above, in the discharging apparatus according to the present invention, the high-voltage trigger is formed of a tri-electrode GDT, and in order to improve a discharge characteristic, a non-linear element, such as an MOV and a TVS diode, may be additionally combined and used.

First, it is determined whether a residual energy discharging condition of the fuel cell is satisfied, and when the residual energy discharging condition of the fuel cell is satisfied, a control operation, in which the fuel cell and the discharge relay are turned on, and the fuel cell and the non-linear protecting element are configured in a closed circuit, is performed.

In this case, an operating condition for each situation for discharging the residual electric energy of the fuel cell will be described as follows:

1) A case where rapid discharging for preventing an overvoltage of the cell of the fuel cell from being formed is necessary according to a determination of a fuel cell control unit immediately after the starting of the vehicle;

2) A case where the starting of the vehicle is stopped;

3) A case where an airbag explosion signal is generated when a vehicle collides; or

4) A case where insulating resistance of the vehicle in a predetermined situation (collision, flooding, insulating aging or a dielectric breakdown of a high-voltage component, or the like) during the travel of the vehicle is decreased to a reference level or lower.

When a controller of the fuel cell vehicle detects that the operating condition for each situation for discharging the residual electric energy of the fuel cell is satisfied, the fuel cell relay 18 between the high-voltage load 16 and the fuel cell 20 and the high-voltage battery relay 24 between the high-voltage battery 22 and the high-voltage 16 are turned off, and the discharge relay 10 is simultaneously turned on, so that the non-linear protecting element 30 and the fuel cell 20 are configured as a closed circuit.

Accordingly, the residual electric energy of the fuel cell is discharged through the non-linear protecting element 30 through the discharge relay 10.

In this case, in order to obtain a faster gas discharging characteristic, the high-voltage trigger 32 is operated, high-voltage trigger power in a pulse form is applied from the direct-current power source to the electrode positioned at the center inside the GDT adopted as the non-linear protecting element 30, so that the residual electric energy of the fuel cell may be rapidly discharged.

Meanwhile, considering that the operating voltage of the fuel cell stack is decreased from an idle state to a maximum load state, a discharge initiating voltage of the discharge apparatus, such as the GDT, the MOV, the TVS diode, or a combination thereof, is set to be lower than a voltage (a minimum value of the operating voltage) at a maximum load of the fuel cell stack.

As described above, it is possible to rapidly remove a residual electric energy of the fuel cell by using the non-linear protecting element having a large discharging current capacity of about several to several tens of kA and a fast discharge operating speed of several ns to several ms, and particularly, it is possible to rapidly remove a residual electric energy of the fuel cell, so that it is possible to decrease generation of a short-circuit and arc due to a severe deformation of the fuel cell stack by a an accident (e.g., a collision) and a direct contact between a high-voltage charging unit and an electric chassis.

What is claimed is:

1. An apparatus for discharging a residual electric energy of a fuel cell, comprising:
a discharge relay turned on when a residual electric energy discharging condition of a fuel cell is satisfied; and
a non-linear protecting element connected with the discharge relay in order to discharge a residual electric energy from the fuel cell.

2. The apparatus of claim 1, wherein the non-linear protecting element is selected from the group consisting of: a Gas Discharging Tube (GDT), a Metal Oxide Varistor (MOV), and a Transient Voltage Suppressor (TVS) diode.

3. The apparatus of claim 1, wherein the non-linear protecting element includes a plurality of: a Gas Discharging Tube (GDT), a Metal Oxide Varistor (MOV), and a Transient Voltage Suppressor (TVS) diode.

4. The apparatus of claim 1, further comprising:
a high-voltage trigger configured to generate high-voltage trigger power in a pulse form and apply the generated high-voltage trigger power to the non-linear protecting element.

5. The apparatus of claim 1, wherein when starting or stopping a vehicle, or a collision detecting sensor detects a collision, or in a predetermined situation during operation of the vehicle including a collision, flooding, and insulating aging or a dielectric breakdown of a high-voltage component, and when insulating resistance of the vehicle is decreased to a reference level or lower, the discharge relay is connected with the fuel cell and turned on.

6. A method of discharging a residual electric energy of a fuel cell, comprising:
determining whether a residual electric energy discharging condition of a fuel cell is satisfied;
when the residual electric energy discharging condition of the fuel cell is satisfied, turning on the fuel cell and a discharge relay, wherein the fuel cell and a non-linear protecting element are arranged in a closed circuit; and
discharging the residual electric energy of the fuel cell through the non-linear protecting element via the discharge relay.

7. The method of claim 6, wherein the non-linear protecting element is selected from the group consisting of: a Gas Discharging Tube (GDT), a Metal Oxide Varistor (MOV), and a Transient Voltage Suppressor (TVS) diode.

8. The method of claim 6, wherein the non-linear protecting element includes a plurality of: a Gas Discharging Tube (GDT), a Metal Oxide Varistor (MOV), and a Transient Voltage Suppressor (TVS) diode.

9. The method of claim 6, further comprising:
generating high-voltage trigger power in a pulse form and applying the generated high-voltage trigger power to the non-linear protecting element.

10. The method of claim 6, wherein the residual electric energy discharging condition includes:
1) a case where rapid discharging for preventing an overvoltage of a cell of the fuel cell from being formed is necessary according to a determination of a fuel cell control unit immediately after a vehicle starts;
2) a case where starting of a vehicle is stopped;
3) a case where an airbag explosion signal is generated when the vehicle collides; and
4) a case where insulating resistance of the vehicle by a collision, flooding, insulating aging or a dielectric breakdown of a high-voltage component is decreased to a reference level or lower during operation of the vehicle.

11. The method of claim 6, wherein a discharging initiating voltage of the non-linear protecting element is set to be lower than a voltage at a maximum load of a fuel cell stack.
